(19) United States
(12) Patent Application Publication
(10) Pub. No.: US 2002/0146121 A1
(43) Pub. Date: Oct. 10, 2002

(54) Method and system for protecting data

(76) Inventor: Eyal Cohen, Kiriat Bialik (IL)

Correspondence Address: FOGG, SLIFER & POLGLAZE, P.A., P.O. Box 581009, Minneapolis, MN, 55458-1009, US

(21) Appl. No.: 10/027,780

(22) Filed: Dec. 20, 2001

(30) Foreign Application Priority Data
Apr. 5, 2001 (IL) 142487

(51) Int. Cl. H04L 9/00

(52) U.S. Cl. 380/201

(57) ABSTRACT

method for authenticating and protecting data, comprising the providing of a plurality of challenging mines dispersed within an executable program file, each mine being dependent on one validation key located in at least one other mine, and optionally on additional keys, for allowing proper use of the executable program file and content files that can be activated by said executable program file.

### FIELD OF THE INVENTION

The invention relates to a method for authenticating and protecting digital data from illegal copying and use. More particularly, the invention relates to a method for protecting digital data that is stored in a Pre-recorded, Recordable or Rewritable media such as CD, DVD and also to digital content such as music and video streams, downloadable digital data and remote operated software, that are provided over the Internet, from illegal copying and use.

### BACKGROUND OF THE INVENTION

Pre-Recorded, Recordable or Rewritable Media

Optical media such as CD-ROM and DVD became major means for storing software due to their inherent features of high density, reliable storage, and a relatively low price. In the past, the piracy in the copying of optical media like CD-ROM was negligible, since recordable machines were available only to professionals, due to their high price. However, in recent years the price of recordable machines, capable of making a perfect copy of original prerecorded CDs and DVDs, has been substantially reduced. Consequently, the rate of illegal copying substantially increased, resulting in significant damages to the software proprietors.

Compact Discs (CD) are an optical storage media of digital information widely utilized for storage of audio, video, text, and other types of digital information. Their reliability, efficiency and low price made their use very common for storage of music, movies, computer software and data. The information stored on the CD may be easily copied, and actually, it is accessible utilizing the basic tools of virtually any computer operating system. The arrival of write-able CDs (CD-R), made the pirate reproduction of CDs a very simple task.

The protection techniques utilized to prevent pirate copying and/or use of digital data are usually based on a wrapping scheme that includes a signature, encryption, and a guarding module.

The signature is utilized to authenticate the original media. The signature is a deviation from the media standard that cannot be imitated by the recording machines designed to produce recorded media according to the media standard. Most patents relating to copy protection focus on the nature of the signature. In other words, the signature is utilized to authenticate the original media by writing authenticating information to locations on the storing media, which may be accessed only for read operations. Thus, any attempts to copy the content of such devices, utilizing standard methods, results in duplicates lacking the signature key.

In many copy protection schemes, the original files of the protected software/data are encrypted, to prevent copying of individual files containing data and execution code. In order to make the final product transparent to the end user, a new executable file is added. This new executable file is known as the guard module, and is utilized to enable the end user, having an original copy, to access the protected software/data.

The guard module performs the authentication of the storage media. The authentication comprises fetching the signature from a predetermined location on the storing media, and verifying that it is the real signature i.e., matching it with an expected value. If the signature exists, and matches, the guard module decrypts the original files (in the case of a protection scheme which includes encryption) and executes/reveals it in order to enable access to the protected software/data. If the guard module is run from a recorded media (a duplicated media produced by a recording device) it will not find the signature, and thus, the original files will not be decrypted and executed/revealed.

This wrapping protection scheme has several drawbacks:

1. The guard module, which is the core of the wrapping copy protection scheme, is an external file that usually has a constant name. Therefore, it is exposed to crackers investigations and tempering.

2. There is only one lock in order to free the software from any protection. Once the “wrapping” has been pulled, the software may be used freely.

3. Once the encryption algorithm is understood, it is possible to decrypt the original executable program file without using the guard module.

4. While the protected software/data is executed/revealed the decrypted files are stored in the computer's memory, and hence, exposed to crackers' attacks.

5. Usually, the original decrypted files may be accessed only while the guard module is running. This constant dependency forces the guard module to run in the background during the entire software execution, and therefore consumes system resources.

There are several methods that exploit the wrapping schemes drawbacks in order to crack the copy protection. Such methods are generally based on:

1. Altering the guard module in order to bypass the signature detection. The altered guard module decrypts and executes/reveals the original files, even if the signature does not exist on the recorded media. The altered guard module, which is, relatively, a very small file, can be easily distributed over the Internet. Consequently, anyone can download the distributed file and use it to run unauthorized copies of the protected software.

2. Decrypting the original files. Once the encryption algorithm is revealed, it is possible to create a small utility that decrypts the original files, i.e., the protected content. Such a utility can be utilized to decrypt any file from different titles using the same encryption algorithm. Moreover, this utility can be distributed over the Internet for other users.

3. Dumping: the original decrypted files may be copied from the computer's memory by utilizing a dedicated utility.

Internet Servers

The Internet has become a significant medium for information and content distribution. There are several types of content consumption that are utilized:

1. Downloadable digital data such as software, pictures, games, music and video files; and

2. Remote operated software using Application Service Providers (ASP).

Downloaded pictures, music and video files are usually not protected due to the lack of an appropriate solution. Thus, the content providers cannot prevent legitimate purchasers from transferring the content to other users. The common method to copy protect downloadable software is to activate the software by using a registration code, which is supplied to the software purchaser. The major drawback to this method is that the purchaser can transfer the code to other users and allow them to activate the software without purchasing it. This, however, is the only solution that has been provided so far.

Application Service Provider (ASP) is a software provider that sells the rights for using the software on a pay per basis or on a lease basis. The right to use the software consists of a registration and license procedure that is performed by the ASP server every time a client wishes to run the software. This procedure resembles the authentication procedure performed by the guard module. A cracker can tamper with the running file of the software so it will not be dependent on the ASP registration and license procedures in order to run. In case the running file or parts of it are stored on the ASP server, it is possible to steal it from the user's computer memory while it runs using a dedicated utility.

A method for protecting optical media from an illegal copy is disclosed in WO 98/41979. This method is based on purposefully damaging the optical medium when the information is initially accessed. Although such protection hardens duplication attempts, there are utilities which enable establishing a complete duplications of optical media and thus bypass such protection scheme. Another protection scheme, disclosed in U.S. Pat. No. 5,418,852, is based on storing authentication information, on areas of the storing media, which are inaccessible for users. However, additional hardware is required to implement this scheme.

All the methods described above have not yet provided satisfactory solutions to the problem of protection of proprietary and copyright content.

It is an object of the present invention to provide a method and apparatus for the protection of digital data from pirate copying, wherein a plurality of integrity and authentication tests are combined into the protected data in concealed locations.

It is another object of the present invention to provide a method for protection of digital data from pirate copying, utilizing an array of integrity and authentication tests wherein the protected data and the integrity and authentication tests, are concealed, and wherein the operation of said authentication tests is transparent to the user.

It is a further object of the present invention to provide a method for the protection of digital data from pirate copying, wherein a protection array comprising integrity and authentication tests is combined, into the protected data, by the content owner/author during development.

It is still another object of the present invention to provide a method for a protection scheme for commercial software and data from pirate copying, which is independent of the storing media such as optical storage media, and Internet servers.

It is still another object of the present invention to provide a method for a copy protection scheme that doesn't constantly consume system resources.

It is still another object of the present invention to provide a method for a copy protection scheme comprising integrity and authentication tests of different types combined into the protected data by the content owner/author to different locations according to his choice.

Other objects and advantages of the invention will become apparent as the description proceeds.

### BRIEF DESCRIPTION OF THE DRAWING

In the drawings:

FIGS. 1a-1e schematically illustrates a procedure for protecting digital data according to a preferred embodiment of the invention.

FIG. 2 schematically illustrates the structure and operation of a mine.

FIG. 3 is a general structure of an anonymous step in a mine in which does not depend on the type of the storing media.

FIG. 4a schematically exemplifies a protection scheme of the prior art; and

FIG. 4b schematically illustrates the protection scheme of the invention.

### SUMMARY OF THE INVENTION

In one aspect, the invention is directed to a method for authenticating and protecting data, comprising providing a plurality of challenging mines dispersed within an executable program file, each mine being dependent on one validation key located in at least one other mine, and optionally on additional keys, for allowing proper use of the executable program file and content files (other data files) that can be activated by said executable program file.

Optionally, the additional keys comprise a signature key stored on a media and accessible by standard devices for read-only, a content key stored on the media of the content files, and an authentication key stored in some type of media remote from the one in use.

Optionally, the mines are concealed within the executable program file, and optionally they may be concealed within the executable program file by means of being encrypted. A portion of the executable program file optionally may be encrypted within the location of a mine, and the proper operation/use of said portion of executable program file is possible only when properly decrypting it using a validation, authentication, or signature key, or a combination thereof, as a decrypting key.

Optionally, the mines are encrypted using a validation, authentication, or signature key, or a combination thereof, and the content files are encrypted by means of content keys. The proper use of a content file protected by a mine may be possible only when finding a corresponding content key for decrypting said file.

Optionally, the proper use of the portion of the executable program file that is protected by a mine further depends on the existence of an authentication key on a medium of the provider of the software, accessible via the Internet.

Optionally, effecting of the mines within the executable program file involves two steps: designating and arming, which may be carried out by two separate entities. The designating step is optionally carried out by the author/producer of the data, and the arming step is optionally carried out by a data protecting professional.

Optionally, the dependence between mines is carried out by means of relative addressing, and the content files may be image, voice, video files, or any other digital file.

### DETAILED DESCRIPTION OF PREFERRED EMBODIMENTS

The invention provides a protection scheme, similar to a “field of mines”, which is suitable for protecting any type of data, including software, sound files, graphic files, image files, etc. The protection scheme of the invention protects these types of data from unauthorized use and/or illegal copying. According to the invention the protection scheme comprises a plurality of challenging mines which are dispersed within the data to be protected (the term “mine” as used herein refers to a software procedure for checking the authenticity and/or validity of the data in use and/or the authorization of the user to use the data).

In the prior art, when an author who produced a data file wanted to protect it, he had to refer to a professional that produced a protection scheme for the data. The protection schemes of the prior art generally include some type of “shell” that protects the data, on which the author does not have any effect. Such protection schemes of the prior art include encryption of the data and a key for decrypting it. When a cracker tries to illegally use the data, he has only to “break” the shell, and then freely use and/or distribute the data. Unlike the prior art which is limited to one shell, according to the invention there is no one shell to break, but there are many challenging mines, each of which performs a different data validation check. The mines and their locations are concealed, so one who wants to break the protection scheme cannot identify their locations and type of performance. Moreover, there is a dependency between mines of the protection scheme, so it is not sufficient to find the location of one mine, but to identify the locations and performance of a plurality of concealed mines in order to break the scheme.

According to a preferred embodiment of the invention, the content owner (the proprietor) of the data is involved in building the protection scheme for his data. Building the protection scheme according to the invention involves two main steps, “designating” and “arming”.

Designating

In this step, generally the author of the data identifies critical portions of data that he wishes to protect. Then, the author marks the beginning and ending of those portions by corresponding flags. Generally, in a preferred embodiment of the invention, the marking is by means of a dedicated Software Development Kit (SDK). Then, the data with the flags within it is provided to a protecting professional for arming.

Arming

In this step the professional arms the data protection scheme by adding to it a plurality of mines at the flag locations. As said, all the mines are concealed within the data, so that a regular user cannot identify them or their locations. Moreover, detection of one or a portion of a mine does not provide breakage of the scheme. After the step of arming, the data is protected.

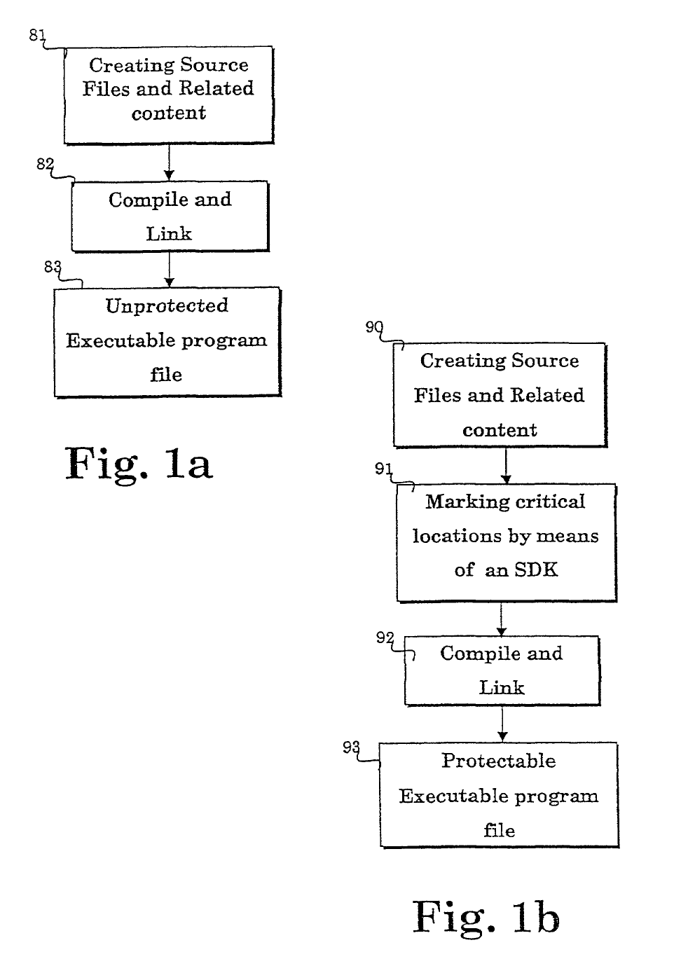

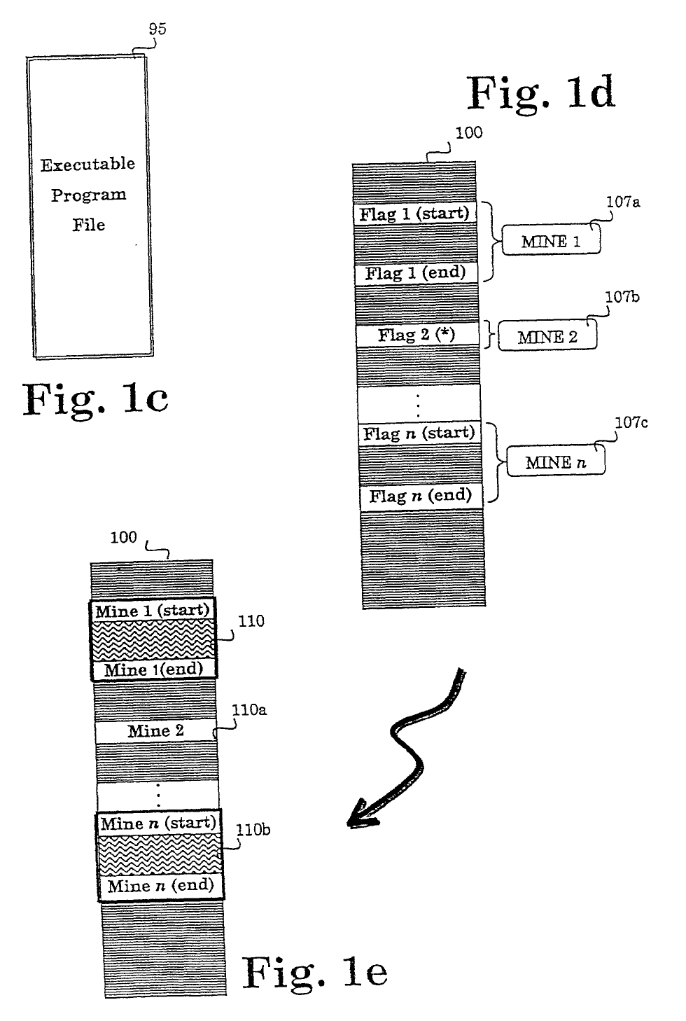

FIG. 1a shows a standard software development procedure. In step 81, source files and optionally their related content files, such as music, videos and/or pictures, are created by a developer. In step 82, the source files are compiled and linked, resulting in an executable program file (step 83). The executable program file is not protected, and it can be used by essentially any user who has a copy of it, and it can be distributed to others which also can use it together with the related content files.

FIG. 1b shows a software development procedure of a protected software according to a preferred embodiment of the invention. In step 90, the developer creates the source files and the related content files in any conventional manner. In step 91 the developer marks by means of SDK functions portions of the source file and the related content that he wishes to protect. In step 92 the source files are compiled and linked resulting in an executable program file capable of being protected. The marks that were introduced into the source files in step 91 become flags that can be recognized by the arming procedure. There are several types of flags, indicating a beginning and ending of a data portion to be protected, or different types of mines to be introduced at their locations.

FIG. 1c shows an executable program file 95 that results from the process described in FIG. 1a. In FIG. 1d the author introduces flags within the executable program file 95, designating the fragments to be protected. More particularly, three types of flags are used, a flag n (start) indicating the beginning of a fragment to be protected, a flag n (end) indicating the end of the fragment to be protected, and flag (*) for indicating a mine that does not occlude any portion of software in between. Then mines 107a, 107b, . . . will be introduced in the arming step using these flag locations. FIG. 1e shows the executable program file after the plurality of mines are introduced into it in the arming step. Portions of the file that are to be protected are occluded within a mine, and are indicated by wavy lines. Furthermore, it should be noted that the wavy lines in FIG. 1e also indicate portions (mine commands) of the mine itself. Generally, the portions 110, 100b, that are indicated by wavy lines are encrypted. The portion 110a includes only encrypted commands of a mine, but not encrypted software within the mine. The portions indicated by 110, 100b of the data and the mines are encrypted by at least one authenticating key or optionally by a combination of several keys. According to the invention, there are several types of keys, as follows:

1. A signature key—A signature key is generally a key which is stored on a media and is accessible by standard devices for read-only. More particularly, in the case of a CD, for example, a standard CD device cannot copy this key from one CD medium to another.

2. Validation key—A validation key is a key which is introduced in specific location within a mine, or which is obtained by a calculation on the content of a mine (e.g., checksum of a mine content, number of bits of a mine, etc.).

3. An authentication key—The authentication key is a key which is stored in some type of media remote from the one in use. For example, the authentication key may be stored in a server, such as the server of the provider of the protected data, that is accessible by the user via the Internet. As will be made clear hereinafter, the authentication key according to the invention preferably reflects some characteristics specific only to the local system of the user, for example, the serial number of his hard disk, who bought and/or paid and/or authorized to use the protected content.

4. Content key—The content key is a key, which is stored on the media where the copy protected content is also stored. The content key is used by mines in order to decrypt portions of the program files or data files.

In the step of arming the various keys are introduced in their appropriate locations and their addresses (or a relative addressing to obtain them) are stored within their related mines.

More particularly, the signature key is introduced in a random location for copying, the validation keys are introduced within the locations of mines, the authentication keys are introduced in locations remote from the system of the user, and if a content is to be protected, the content key should also be introduced on the storing media of the content.

Furthermore, in the step of arming, the relevant address references are saved within each mine to indicate the location/s of the relevant keys. For example, in the case of a signature key, the address reference will lead to the location of the signature key, for example, on a CD medium; in the case of a validation key, the relative address of the key will be saved within the mine; in the case of a authentication key, the address will lead to a location within a remote site; and in the case of a content key, the address will lead to the location of a key stored on the content medium. Said keys will be used by the relevant mines for authentication/verification purposes, and as keys for encryption and decryption of data and/or portions of the mine.

According to the invention, each mine introduces a challenge to the proper continuation of the software execution. If the challenge fails, the operation may terminate, a demonstration may be provided to the users or a suitable message may be initiated.

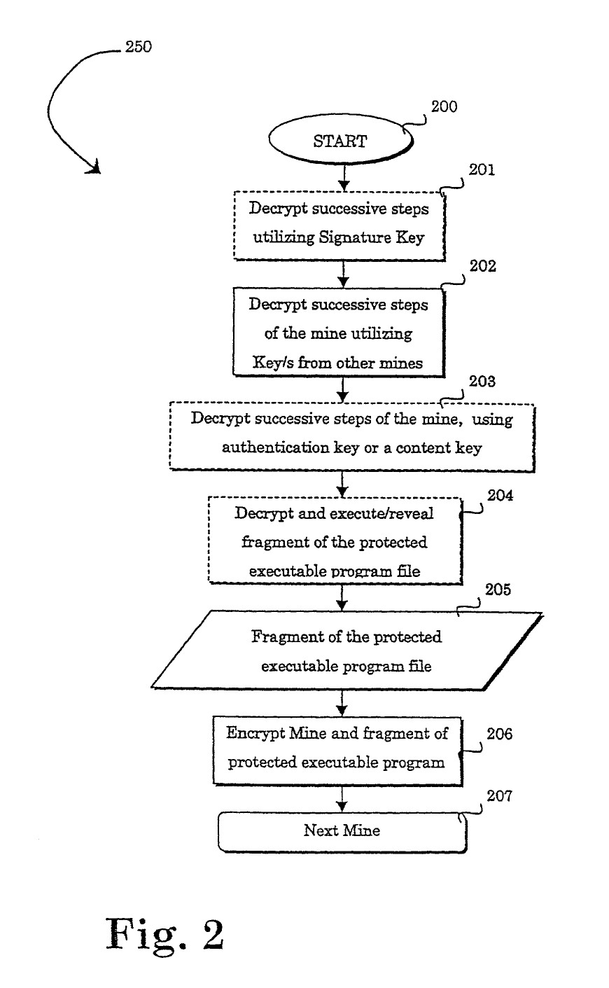

FIG. 2 illustrates a preferable structure of a mine 250, according to one embodiment of the invention. Steps that are shown in these figures in dotted lines are optional. Referring to FIG. 2, in step 200 the operation of the mine begins. In the optional step 201, the mine detects the signature key and decrypts the following steps of the mine if they are encrypted. In step 202, the mine uses one or more keys from other mines to decrypt successive steps of the mine. In the optional step 203, the mine decrypts, following steps of the mine using an authentication key or a content key (when a content is to be protected). In step 204, the mine uses one or more of the above keys to decrypt encrypted fragment 205 of the protected software. This fragment 205 is actually the software fragment that the author chooses to protect. It is not possible to run the protected software fragment without executing the mine, i.e., passing the entire authentication and decryption procedures of the mine. After the decrypted software fragment by the mine 250, in step 206, the mine re-encrypts the software fragment 205, and the mine itself, by the same key/s as were used for its decryption. Then, the procedure continues in step 207, until reaching another mine.

It should be noted that at any given time within the process described in FIG. 2, each step within an individual mine encrypts the previous step. In this way, only a very small portion of the mine is exposed to investigation by a potential hacker at any given time.

In at least one case on each medium, the signature key must be detected. If the signature key does not exist (such as on an illegal copy, for example) then the decryption of the following mines and subsequent content unlocking will not occur.

It should be noted that according to the invention, the portions of the mine and the fragments of the data are so encrypted that the relative address between mines remains the same in both the encrypted form and the decrypted form in order to enable the mine to properly find the validation keys within the locations of other mines. There are known encryption schemes that keep the size of a content the same in both an encrypted and a decrypted form, and such known schemes may be used by the mines of the invention. Furthermore, the order of performance of some steps within the mine may change, and/or more than one fragment of the software may be encrypted within one mine. Moreover, the keys may reflect some properties of the protected data, the storing media, and/or of some physical properties of the system of the user or of the data provider. For example, a key may be used to reflect the size of a data portion, and if such potion is tampered with, this may be detected by the protection scheme.

As described, the proper operation of each mine depends on a key saved in at least one other mine. Therefore, if one mine is tampered with, the operation of at least one other mine that depends for its proper operation on the key that is stored within it, will fail.

Content Protection

In many cases, it is desired to protect various content files, such as multimedia files comprising images, audio, videos, etc. Generally, these content files require for their activation and/or operation a dedicated activating software. According to the invention, the activating software is protected by mines dispersed within it, as described above. The content files are encrypted and content keys for their decryption are dispersed on their storing media. There are two distinct cases which exist: in the first case, the content files and the activating software are stored on the same medium, and in the second case, they are stored on two different media. An example for the second case is when the activating software is stored on the hard disk of the user and the content files are stored in a CDROM.

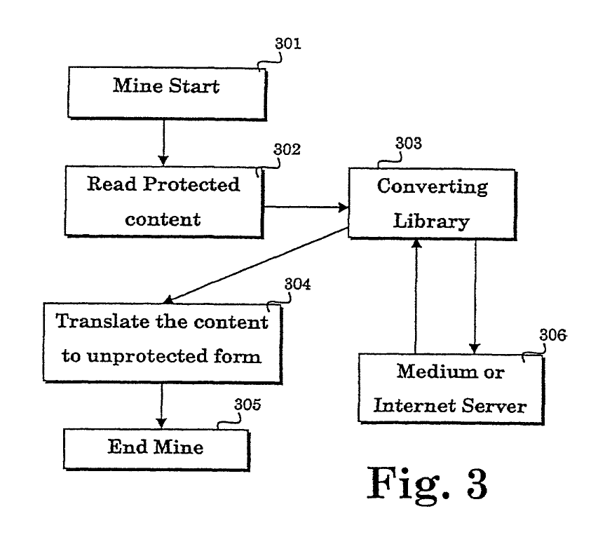

The protection scheme described above is suitable for protecting data (software or content) saved over any type of medium. In cases requiring the same data to be distributed on different types of media such as on a CD, DVD, an Internet server, etc., it is desirable to have one unit of protected data which is suitable for different types of media. FIG. 3 shows a scheme of how this can be obtained. Generally, the only steps in the mine of FIG. 2 which are media-dependent are steps 201 and 203, which look for signature or content keys on the media. The location, for example, of the signature key on a CD is different from the location on a diskette or a DVD. In the case when both the content files and the activating software are stored on the same medium (the first case as mentioned above), all the addresses to the keys are stored within the mines. However, when the activating file and the content files are distributed separately to users, and are stored on two different media, a special arrangement is provided, as described in FIG. 3. In that case, a converting library for the addresses is provided on the storing medium. In step 302, the mine looks for the signature and/or content keys. It refers to a converting address library 303, which is specific to the media used. The converting library 303 is a separate data file stored on the storing media, capable of converting any reference to a signature and/or content keys within the media, according to the specific medium used. Unit 303 goes to the medium 306, and obtains a signature and/or a content key, and provides the same to the protection scheme, which continues in step 304, in which it utilizes it. Generally, it uses the obtained key to decrypt a content file. It should be noted that unit 303 is a data file separated from the protected content and the protection scheme. A suitable Unit 303 is installed according to the media used.

As shown, the invention provides a method for protecting and authenticating data from unauthorized use and/or copying. The use of a plurality of mines dispersed within the data and dependent each on at least one other mine provides a very efficient means for protection. In order to break the protection, a potential cracker has to detect all the mines that are dispersed and concealed within the software. Moreover, he has to find a plurality of keys of several types that are also concealed within the plurality of mine locations and/or in other places, and then to decrypt the mines and the protected content. At any given time, only a small portion of the encrypted data or content is decrypted and the rest of it remains encrypted. Moreover, most of the mines are encrypted and concealed and even most of the active mine itself remains encrypted and only a small portion of it is decrypted at any given time. The protection scheme of the invention is suitable for use with any type of data, distributed by any type of medium or via the Internet.

It should be noted that in the prior art schemes for protecting software once the guard module is neutralized, it can be easily distributed to users which have an unauthorized (illegal) copy of the protected software, who in turn can freely use the software. According to the invention, only a full version of the data (if cracked) should be distributed in order to be illegally used. Moreover, the guard module used in the prior art runs in the background during all the operation of the protected software and it therefore consumes computer resources, and reduces the computer performance. On the other hand, the protection scheme of the invention does not run in the background, and is activated only when a challenging mine is reached. Therefore, there is essentially no harm to the performance of the computer.

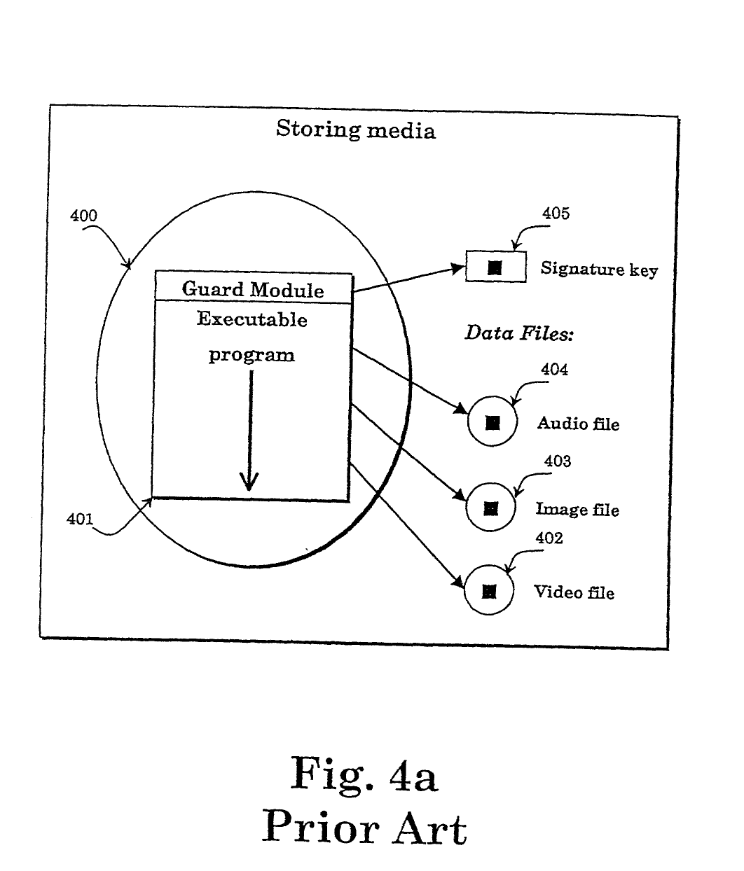

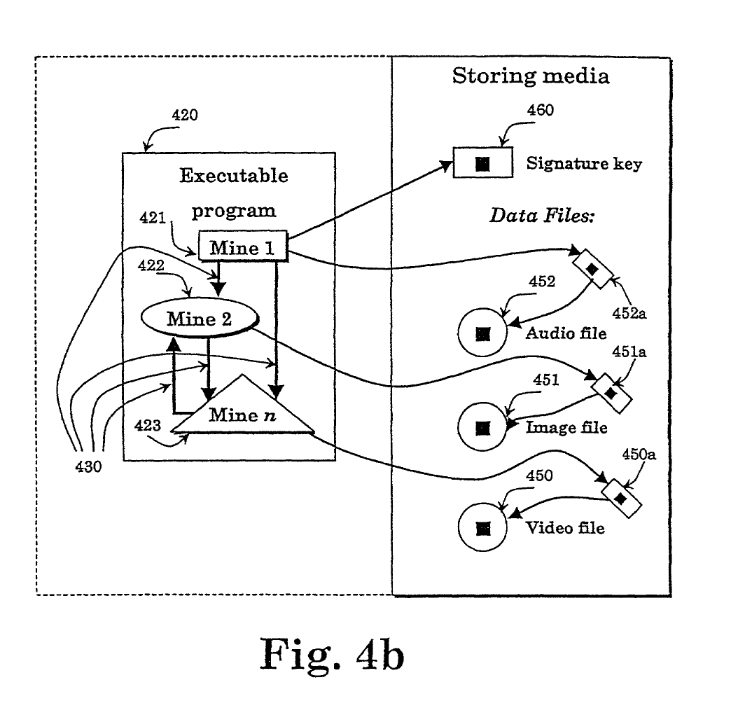

FIGS. 4a and 4b illustrate the main differences between the protection scheme of the invention and of a typical protection scheme of the prior art. FIG. 4a illustrates a protection scheme according to the prior art. The protection scheme includes a guard module 400, and an executable program file 401 that is protected by said guard module. The executable program file may be used for opening a video file 402, an image file 403, or an audio file 404, which are generally not encrypted. The executable program file checks for the existence of a signature key 405. Once the guard module 400 is invalidly neutralized, all the content can be freely used.

FIG. 4b illustrates the protection scheme of the invention. According to the invention, there is no single guard module to neutralize. On the other hand, the executable program file 420 contains a plurality of mines, for example, mines 421, 422, and 423, of different types. The mines are encrypted and concealed within the executable program file 420, and each mine occludes within it a portion of the executable program file. At any given time only a portion of the executable program file, and/or a portion of one mine is decrypted. At least one mine within the executable program file 420 checks for the existence of a signature key 460 and each mine depends for its proper operation on at least one key retrieved from another mine. The keys (not shown) that are retrieved from other mines are used for the decryption of the active mine and/or the data occluded within it. Arrows 430 indicate the dependencies of the mines one on the others. Moreover, the invention also provides protection of audio video or image files. According to the invention, all content files, defined by the content owner, are encrypted. The decryption of the content files 450, 451, and 452, is performed by the mines respectively using content keys 450a, 451a, and 452a, as keys for decryption. The executable program file, 420 can be stored either on the same medium or on a different medium.

It should be noted that according to the method of the invention the executable program file 420 (in a dashed line frame), and the protected content are not necessarily stored on the same storing media, and as was discussed herein before, the executable content file may be distributed separately, or even downloaded from the Internet.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for authenticating and protecting data, comprising the providing of a plurality of challenging mines dispersed within an executable program file, each mine being dependent on one validation key located in at least one other mine, and optionally on additional keys, for allowing proper use of the executable program file and content files that can be activated by said executable program file.

2. A method according to claim 1, wherein the additional keys comprise:
a signature key stored on a media and accessible by standard devices for read-only;
a content key stored on the media of the content files; and
an authentication key stored in some type of media remote from the one in use.

3. A method according to claim 1, wherein the mines are concealed within the executable program file.

4. A method according to claim 3, wherein the mines are concealed within the executable program file by means of being encrypted.

5. A method according to claim 1, wherein a portion of the executable program file is encrypted within the location of a mine.

6. A method according to claim 1, wherein the mines are encrypted.

7. A method according to claim 5, wherein the proper operation/use of said portion of executable program file is possible only when properly decrypting it using a validation, authentication, or signature key, or a combination thereof, as a decrypting key.

8. A method according to claim 1, wherein the mines are encrypted using a validation, authentication, or signature key, or a combination thereof.

9. A method according to claim 2, wherein the content files are encrypted by means of content keys.

10. A method according to claim 9, wherein the proper use of a content file protected by a mine is possible only when finding a corresponding content key for decrypting said file.

11. A method according to claim 2, wherein the proper use of the portion of the executable program file that is protected by a mine further depends on the existence of an authentication key on a medium of the provider of the software, accessible via the Internet.

12. A method according to claim 1, wherein the effecting of the mines within the executable program file involves two steps: designating and arming.

13. A method according to claim 12, wherein the designating and arming steps are carried out by two separate entities.

14. A method according to claim 13, wherein the designating step is carried out by the author/producer of the data.

15. A method according to claim 13, wherein the arming step is carried out by a data protecting professional.

16. A method according to claim 1, wherein the dependence between mines is carried out by means of relative addressing.

17. A method according to claim 1, wherein the content files are image, voice, video files, or any other digital file.
